(19) United States
(12) Patent Application Publication
(10) Pub. No.: US 2008/0302603 A1
(43) Pub. Date: Dec. 11, 2008

(54) LADDER PLATFORM AND SAFETY RAIL DEVICE

(76) Inventor: Burton D. Madison, Kansas City, MO (US)

Correspondence Address: MARK BROWN, 4700 BELLEVIEW SUITE 210, KANSAS CITY, MO, 64112, US

(21) Appl. No.: 11/759,688

(22) Filed: Jun. 7, 2007

(51) Int. Cl. E06C 7/16; E06C 7/18

(52) U.S. Cl. 182/106; 182/117

(57) ABSTRACT

A ladder platform and safety rail device is provided for mounting on one or more ladders and includes a U-shaped bracket with an insert leg for extending through a hollow ladder rung. The bracket also includes a rail leg, which is releasably connected to a rail. The bracket legs extend through a bracket leg plate, which secures their ends together with the device mounted on one or more ladders. A working deck is formed by a plank supported on a ladder jack attached to each ladder. A rail support strut extends between the rail and the plank.

### BACKGROUND OF THE INVENTION

1. Field of the Invention

The present invention relates generally to ladder accessories, and in particular to an elevated platform and safety rail device for mounting on one or more ladders.

2. Description of the Related Art

Various types of ladders and scaffolding systems are available for providing elevated work platforms. For example, my U.S. Pat. No. 3,792,750, which is incorporated herein by reference, shows a safety device for ladders. A pair of the safety devices shown therein can be utilized for supporting a platform extending between a pair of ladders, which can be leaned against the side of a building or other structure. Elevated parts of a structure, which would otherwise be beyond reach from an adjacent ground surface, can thus be made accessible from a structurally sound platform on which workers can stand and materials, tools and equipment can be placed. The platform itself can be accessed from either of the supporting ladders.

In addition to a stable platform, a safety rail is highly desirable from a safety standpoint. On many jobs, such as building construction and maintenance, workers would need such a rail or other safety device, such as a harness or bosun's chair, in order to safely work at any significant height. Railings may also be required by codes and safety regulations (e.g., OSHA) in many jurisdictions. In addition to safety considerations, other design criteria for such devices include convenience of use, quick set-up and takedown, platform adjustability for height and width and adaptability to different ladders. The present invention addresses these considerations. Heretofore there has not been available a ladder platform and safety rail device with the advantages and features of the present invention.

### SUMMARY OF THE INVENTION

In the practice of an aspect of the present invention, a platform and safety rail device is provided for use with one or more ladders. In a two-ladder configuration, the device includes a pair of ladder jacks, which provide support for a plank or planks forming a working deck, a pair of U-brackets, a crossbar extending between the brackets and a post connecting the crossbar and the working deck.

### BRIEF DESCRIPTION OF THE DRAWINGS

FIG. 1 is a perspective view of a ladder platform and safety rail device embodying an aspect of the present invention, shown mounted on a pair of ladders leaning against a structure.

FIG. 2 is an enlarged, fragmentary, exploded perspective view of the device, particularly showing bracket legs and a bracket leg plate for mounting on a ladder.

FIG. 3 is an enlarged, fragmentary, exploded perspective view of the device, particularly showing the connection of a strut to a safety rail.

FIG. 4 is an enlarged, fragmentary, exploded perspective view of the device, particular showing the connection of the strut to a plank forming a working deck.

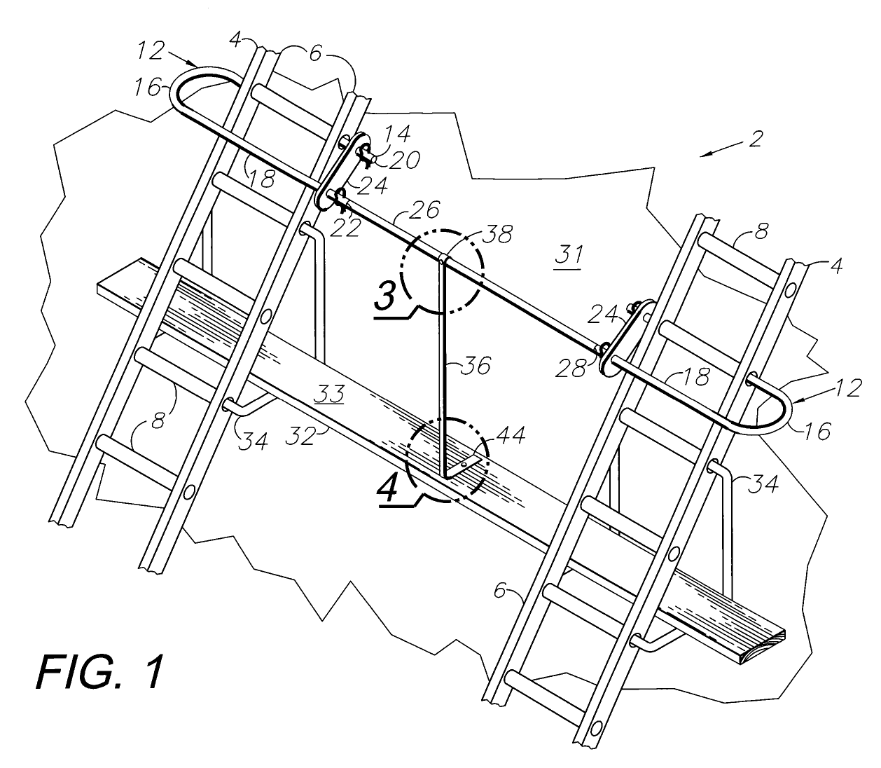

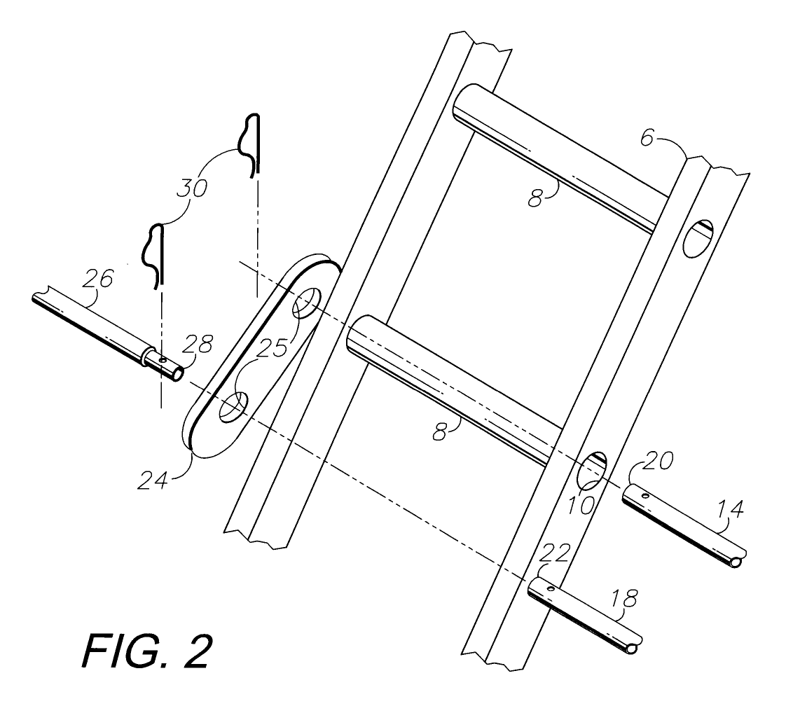

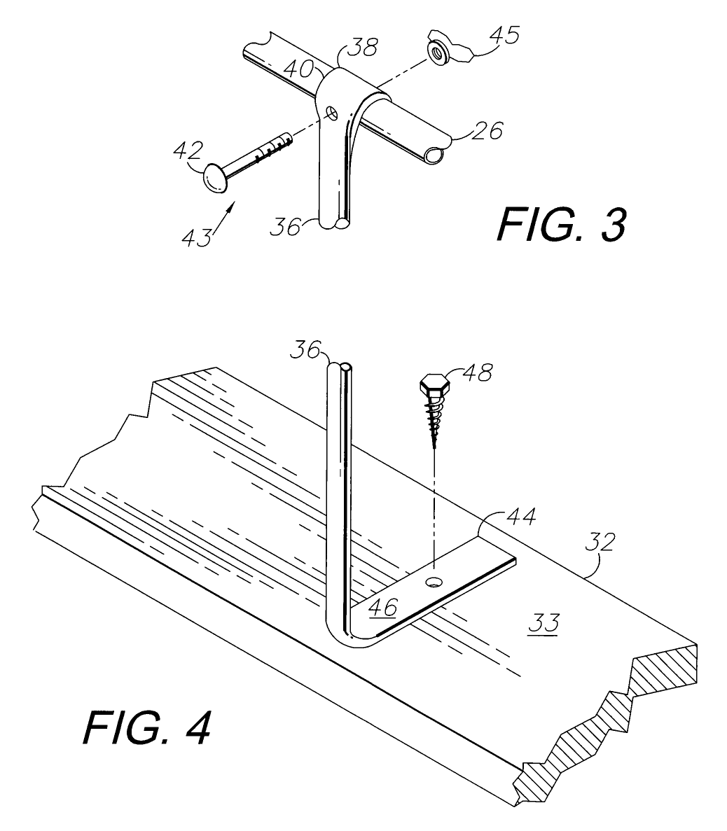

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning.

### II. Ladder Platform and Safety Rail Device 2

Referring to the drawings in more detail, the reference numeral 2 generally designates a ladder platform safety rail device embodying an aspect of the present invention. By way of example and without limitation, the device 2 is shown mounted on a pair of ladders 4. Alternatively, the device 2 can be mounted at one end to a single ladder and supported at the other end by some other structure, or it can extend across three or more ladders. Each ladder 4 has a pair of side members 6 and multiple, spaced rungs 8 extending therebetween. In a common type of ladder construction the rungs 8 are hollow and open-ended at the members 6 whereby each rung 8 defines an open-ended passage 10 extending transversely across the ladder 4. Alternatively, the ladders 4 can comprise, for example, extension ladders with one or more extendable and retractable sections.

The device 2 includes a pair (for the two-ladder configuration shown) of U-shaped brackets 12, each including an insert leg 14, a 180° return 16 and a rail leg 18. The bracket legs 14, 18 terminate at respective inside ends 20, 22, which are secured together by a removable bracket leg plate 24 with receivers 25 receiving the bracket leg inside ends 20, 22. A safety rail 26 can comprise, for example, a length of steel tubing, and has opposite rail ends 28 each telescopically received in a respective inside rail leg end 22 and secured therein by a respective, removable retaining pin 30. Optional retaining pins 30 can be provided for retaining the bracket leg plates 24 on the insert legs 14 as shown. However, the downward, gravitational load associated with the weight of the device 2 tends to spread the bracket legs 14, 18 and thereby secure and retain the bracket leg plates 24 in place under tension whereby the retaining pins 30 extending through the bracket leg inner ends 20 may be unnecessary.

A platform plank 32 forms a working deck 33 and is supported at each ladder 4 by a respective ladder jack 34, which can comprise the type of ladder jack shown in my U.S. Pat. No. 3,792,750, or some other suitable device for mounting a plank or planks on the ladders 4. As shown, the plank 32 is located generally behind the ladders 4, i.e. between the ladders 4 and a structure such as a wall 31 against which the ladders 4 can be leaned in order to provide access thereto from the working deck 33. Other platform structures, e.g. multiple planks, metal decking, etc., can also be utilized to form the working deck 33. A plank support strut 36 is connected to and supports the plank 32 by suspending it from the rail 26, to which the strut 36 is also connected. The strut 36 includes an upper end 38 forming a hook 40 adapted for placement over the rail 26 and removably attached thereto by a suitable mechanical fastener 42, such as a bolt 43 and a wingnut 45. A lower end 44 of the plank support strut 36 forms a generally horizontal foot 46, which can optionally be flattened and receive a mechanical fastener, such as a lag screw or screws 48, for releasable attachment to the plank 32.

The device 2 can be assembled with the ladders 4 either on the ground or propped against the structure wall 31. The structure wall 31, elevated portions of which are accessible from the working deck 33, can comprise a wall of any of various buildings or other structures. Alternatively, the structure can comprise a natural formation, such as a cliff face, tree trunks, etc. The brackets 12 are installed by inserting their respective insert legs 14 through the respective ladder rung passages 10. The brackets 12 are attached to the ladders 4 by mounting the bracket leg plates 24. The rail ends 28 are inserted into the bracket rail leg ends 22 and retained therein by the spring-loaded retaining pins 30. The ladders 4 can then be individually placed against the structure (if not already in place) and the plank 32 can be placed on the ladder jacks 34. The rail 26 is attached at its ends 28 to the bracket return ends 22. The strut 36 is attached to the rail 26 and the plank 32. It will be appreciated that the device 2 can also be installed with the ladders 4 in place.

It is to be understood that the invention can be embodied in various forms, and is not to be limited to the examples discussed above. Other components and configurations can be utilized in the practice of the present invention. For example, with more than two ladders, a bracket can be configured for mounting a rail at both ends and bracket leg plates 24 can be placed on both sides of the ladder 4. The device 2 can also be adapted for mounting on other types of ladders. Moreover, the safety rails 26 can be configured for connecting end-to-end (e.g., with each rail having opposite male and female ends or by utilizing connectors mounted on adjacent rail ends 28) in order to provide a longer device 2 accommodating ladders 4 spaced further apart.

Having thus described the invention, what is claimed as new and desired to be secured by Letters Patent is:

1. A platform support and safety rail device for connection to a ladder, which device comprises:
a rail assembly including a bracket with a first leg adapted for connection to the ladder and a second leg connected to and located in spaced relation from said first leg;
said rail assembly further including a rail with an end connected to the bracket second leg; and
a platform assembly comprising a platform having a working deck and being located below said rail with said ladder in a generally upright position; said platform assembly further including a ladder jack connected to said platform and said ladder and supporting said platform on said ladder.

2. The device according to claim 1, which includes:
said bracket comprising a first bracket and said ladder jack comprising a first ladder jack;
a second bracket for connecting said rail to a second ladder; and
a second ladder jack for supporting said platform on the second ladder.

3. The device according to claim 1, which includes:
said ladder including multiple rungs with generally hollow, tubular configurations; and
said bracket first leg comprising an insert leg adapted for placement generally within a rung of said ladder.

4. The device according to claim 3, which includes:
a bracket leg plate including a pair of receivers each receiving a respective bracket leg with said bracket mounted on said ladder.

5. The device according to claim 4, which includes:
each said bracket leg including an end with a receiver; and
a pair of retaining pins each removably receivable in a respective said bracket leg end receiver.

6. The device according to claim 5, which includes:
said rail end and said rail leg end being configured for telescopic interconnection and said telescopic interconnection being configured for receiving a respective said retaining pin extending therethrough with said bracket mounted on the ladder.

7. The device according to claim 1, which includes:
a strut with an upper end connected to said rail and a lower end connected to said platform.

8. The device according to claim 7, which includes:
said strut upper end forming a hook configured for placement over said rail; and
said strut lower end forming a foot configured for placement on said platform.

9. The device according to claim 2, which includes:
a third bracket adapted for mounting said platform on a third ladder;
said first and third brackets having U-shaped configurations with approximately 180 degree returns; and
said first and third brackets having U-shaped configurations with approximately 180 degree returns; and
said second bracket including an insert leg adapted for insertion in a respective rung of said second ladder;
each said insert leg having an end;
a pair of rail sections each having opposite ends, one of said rail sections extending between said first and second brackets and the other of said rail sections extending between said second and third brackets; and
multiple bracket leg plates each having a first receiver receiving a respective insert leg and a second receiver receiving one of a respective bracket rail leg end and a respective rail end, one each of said bracket leg plates being mounted adjacent to said first and third ladders and a pair of said bracket leg plates being mounted adjacent to said second ladder with said second ladder therebetween.

10. The device according to claim 1 wherein said platform comprises a wooden plank.

11. A ladder platform and safety rail device for a pair of ladders each including a pair of ladder side members and multiple, hollow, tubular ladder rungs extending between and open at said side members, which device includes:
a rail assembly including a pair of brackets each having an insert leg adapted for placement generally within a rung of said ladder and a rail leg connected to and located in spaced relation from said insert leg;
said rail assembly further including a rail with opposite ends each connected to a respective bracket rail leg;
said rail assembly further including a pair of bracket leg plates each including a pair of receivers each receiving a respective bracket leg with said brackets mounted on said ladders;
a platform assembly comprising a platform having a working deck and being located below said rail with said ladders in generally upright positions; said platform assembly further including a pair of ladder jacks each connected to a respective ladder and supporting said platform thereon; and
a strut with an upper end connected to said rail and a lower end connected to said platform.

12. The device according to claim 11, which includes:
each said bracket leg including an end with a receiver; and
multiple retaining pins each removably receivable in a respective said bracket leg receiver.

13. The device according to claim 12, which includes:
each said rail end being configured for telescopic interconnection with a respective rail leg end and each said telescopic interconnection being configured for receiving a respective said retaining pin extending therethrough with said brackets mounted on the ladders.

14. The device according to claim 11, which includes:
said strut upper end forming a hook configured for placement over said rail; and
said strut lower end forming a foot configured for placement on said platform.

15. A ladder platform and safety rail device for a pair of ladders each including a pair of ladder side members and multiple, hollow, tubular ladder rungs extending between and open at said side members, which device includes:
a rail assembly including a pair of U-shaped brackets each having an insert leg adapted for placement generally within a rung of said ladder and a rail leg connected to and located in spaced relation from said insert leg;
each said bracket including an approximately 180° curved return connected to and extending between said bracket legs;
said rail assembly further including a rail with opposite ends each connected to a respective bracket rail leg;
said rail assembly further including a pair of bracket leg plates, each bracket leg plate including a pair of receivers and each receiver receiving a respective bracket leg with said brackets mounted on said ladders;
each said rail end being adapted for telescopic interconnection with a respective bracket rail leg end;
multiple retaining pins each removably receivable in a respective telescopic interconnection;
a platform assembly comprising a plank with a working deck and being located below said rail with said ladders in generally upright positions; said platform assembly further including a pair of ladder jacks each connected to a respective ladder and supporting said plank thereon;
a generally tubular strut with a flattened upper end connected to said rail and a flattened lower end connected to said plank;
said strut upper end forming a hook configured for placement over said rail;
an upper strut mechanical fastener extending through said strut upper end and said rail;
said strut lower end forming a foot configured for placement on said platform; and
a lower strut mechanical faster extending through said strut lower end and into said plank.
